(19) United States
(12) Patent Application Publication
(10) Pub. No.: US 2006/0193320 A1
(43) Pub. Date: Aug. 31, 2006

(54) Data transmission method having improved network address translation method in home gateway and a system thereof

(75) Inventors: Dong-yun Shin, Seongnam-si (KR); Yoo-seung Hwang, Seoul (KR); Chang-hwan Park, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/360,776

(22) Filed: Feb. 24, 2006

(30) Foreign Application Priority Data
Feb. 28, 2005 (KR) 10-2005-0016789

(51) Int. Cl. H04L 12/28; H04L 12/56

(52) U.S. Cl. 370/389; 370/395.2

(57) ABSTRACT

A data transmission method and a data transmission system using an improved network address translation method. The data transmission method includes requesting a real-time service from a multimedia device to a home gateway within a home network; inputting a binary code corresponding to the multimedia device to a service type field indicating priority information of data when the home gateway forms a mapping table used for conversion of addresses; the home gateway requesting setting of an IP address of the multimedia device from a service provider; setting the IP address including the binary code corresponding to the multimedia device according to the request of setting the IP address; and the service provider transmitting a data packet including the binary code corresponding to the multimedia device. The method is applied to the selective IP packet, thereby shortening the transmission time of real-time data packets for multimedia.

### CROSS-REFERENCE TO RELATED APPLICATIONS.

This application claims benefit under 35 U.S.C. § 119 from Korean Patent Application No. 10-2005-0016789, filed on Feb. 28, 2005, the entire content of which is incorporated herein by reference.

### BACKGROUND OF THE INVENTION

1. Field of the Invention

Systems and methods consistent with the present invention relate to transmitting data on a network, and more particularly to transmitting data with an improved network address translation method in a home gateway and a system thereof.

2. Description of the Related Art

Since the number of Internet Protocol version 4 (IPv4) addresses of domestic Internet service providers is limited, they cannot satisfy the increasing demand by Internet users for IPv4 addresses. This phenomenon will last for quite some time. The majority of experts forecast that the problem can be solved by an Internet Protocol version 6 (IPv6) address scheme. However, considerable amount of time is needed to popularize the IPv6 address scheme. Accordingly, it is necessary to solve the problem related to the depletion of IPv4 addresses and provide a stable supply of IPv4 addresses to the rapidly increasing Internet users. Presently, a Network Address Translator (NAT) method is proposed to solve the problem related to the depletion of IPv4 addresses. The NAT method is the technique for maintaining a pool of IPv4 and translating each of the Internet users' private IP packet addresses to dynamic public IPv4 addresses provided from the NAT.

A data transmission system using an improvement of a network address translation method in a home gateway includes the NAT (Network Address Translator). As described above, the NAT is a system for translating addresses to be connected with a global IP address space, in a private IP address space. Namely, the NAT performs an address translation function to perform a communication function between a host within an organization having private addresses and a host within an organization having IP addresses. Here, the global IP addresses are addresses used on Internet connected to all places of the world and the private addresses are addresses used within the organization disconnected from Internet. The NAT is used when there is a lack of global addresses for the Internet within the organization. For example, the NAT may be used in a case of using proper IP addresses assigned within the organization without applying formally the global IP addresses, or a case of assigning the IP addresses within the organization to the private IP addresses because of the depletion of the IP addresses within the organization. The NAT is used mainly for converting the addresses of the IP packet header and the Transmission Control Protocol/User Datagram Protocol (TCP/UDP) port. A communicating process using an application can be performed by converting the addresses of the IP packet header and the TCP/UDP port.

FIG. 1 is a configuration diagram of a conventional data transmission system using an improvement of a network address translation method in a home gateway. A home network and an access network are configured by using a home gateway 100 as a contact point. A plurality of devices 110a and 110b existing in the home network convert addresses in the home gateway 100 and transmits IP data. When converting the addresses in the home gateway 100, one public IPv4 address is converted to a plurality of private IPv4 addresses by using a TCP/UDP port number of a layer 4 (transport) of an OSI 7 layer. Namely, the plurality of devices 110a and 110b existing in the home network has the private IPv4 addresses to communicate with one service provider and performs the communication function by a NAT function of the home gateway 100. However, the conventional method needs an address identification process to the layer 4, since the NAT translates the addresses by using the IP addresses and the TCP/UDP port number of the layer 4. Typically, as the address identification process needs a lot of time, the conversion of the addresses of the IP packet in the real-time service and the multimedia service is very inefficient with regard to data transmission speed. Accordingly, the communication using the conventional NAT method is unsuitable for the multimedia device for receiving the real-time service.

### SUMMARY OF THE INVENTION

The present invention provides a data transmission method using an improvement of a network address translation method in a home gateway and a system thereof.

According to an aspect of the present invention, there is provided a data transmission method including: requesting a real-time service from a multimedia device to a home gateway within a home network; inputting a binary code corresponding to the multimedia device to a service type field indicating priority information of data when the home gateway forms a mapping table used for conversion of addresses; the home gateway requesting setting of an IP address of the multimedia device from a service provider; setting the IP address including the binary code corresponding to the multimedia device according to the request of setting the IP address; and the service provider transmitting a data packet including the binary code corresponding to the multimedia device.

The data transmission method further includes: converting the IP address of the multimedia device by using the binary code; and transmitting the data packet to the multimedia device. In the step of inputting the binary code corresponding to the multimedia device to the service type field, 01, 10, and 11 are sequentially input according to a request order of the multimedia device from the home gateway. When the multimedia device requests the real-time service from the home gateway after 01, 10, and 11 are input, the home gateway rejects the request of the multimedia device.

In addition, when the multimedia device requests the real-time service from the home gateway after 01, 10, and 11 are input, the home gateway deletes the mapping table related to the multimedia device, corresponding to the first assigned binary code, and assigns the first assigned binary code to the service type field of the mapping table related to the multimedia device. In the forming the mapping table used for the conversion of the address, a private IP and a port number are extracted from the multimedia device, and the extracted private IP and the extracted port number are assigned into the mapping table. In the converting the IP address of the multimedia device by using the binary code, the mapping table is searched and the IP address of the multimedia device is converted.

In the inputting the binary code corresponding to the multimedia device to the service type field, the binary code is input to unused bits of the service type field.

According to another aspect of the present invention, there is provided a data transmission system in a home gateway, comprising a home gateway for converting protocols by connecting a plurality of communication networks to each other; a multimedia device on the home network; and a service provider for transmitting data to the home gateway, wherein the multimedia device requests a real-time service from the home gateway and receives a data packet for the real-time service. When forming a mapping table used for conversion of an address, the home gateway inputs a binary code corresponding to the multimedia device to a service type field indicating priority information of the data, and requests the setting of the IP address of the multimedia device to the service provider. The service provider sets the IP address including the binary code corresponding to the multimedia device according to the request of setting the IP address, and transmits the data packet including the binary code corresponding to the multimedia device.

The home gateway converts the IP address of the multimedia device by using the binary code. In addition, the home gateway transmits the data packet to the multimedia device. Also, the binary code is two bits. Further, the home gateway inputs sequentially 01, 10, and 11 according to a request order of the multimedia device from the home gateway. When the multimedia device requests the real-time service from the home gateway after inputting 01, 10, and 11, the home gateway rejects the request of the multimedia device.

When the multimedia device requests the real-time service from the home gateway after inputting 01, 10, and 11, the home gateway deletes the mapping table related to the multimedia device corresponding to the first assigned binary code and assigns the first assigned binary code to the service type field of the mapping table related to the multimedia device. In addition, when the home gateway forms the mapping table used for the conversion of the address, the home gateway extracts a private IP and a port number from the multimedia device, and assigns the extracted private IP and the extracted port number into the mapping table.

Further, the home gateway searches the mapping table and converts the IP address of the multimedia device. The home gateway inputs the binary code corresponding to the multimedia device to the unused bits of the service type field when assigning the binary code corresponding to the multimedia device to the service type field.

### BRIEF DESCRIPTION OF THE DRAWINGS

The above and other aspects of the invention will become apparent from the following description of exemplary embodiments taken in conjunction with the accompanying drawings, in which:

FIG. 1 is a configuration diagram of a conventional data transmission system using an improvement of a network address translation method in a home gateway;

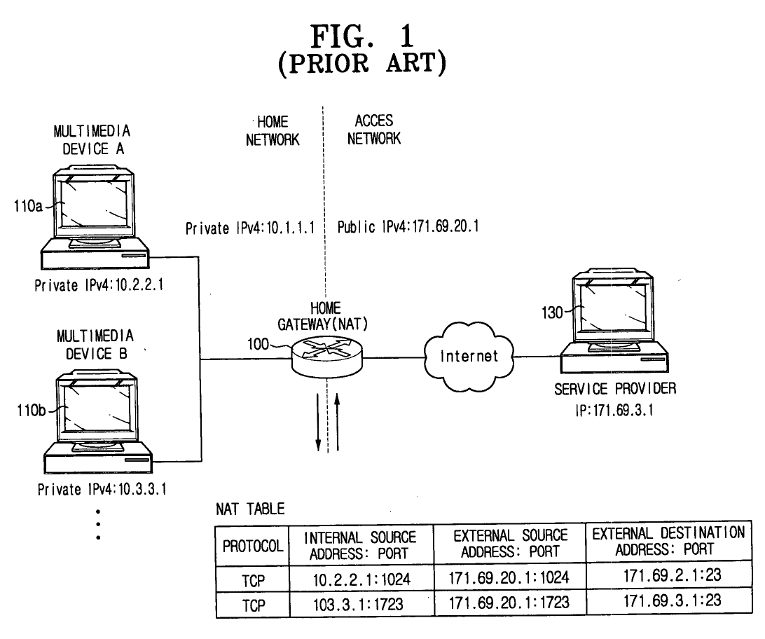

FIG. 2 is an overall flowchart illustrating a data transmission method using an improvement of a network address translation method in a home gateway according to an exemplary embodiment of the present invention;

FIG. 3 is a diagram illustrating an IP service type field in an IP header used for an exemplary embodiment of the present invention;

FIG. 4 is a diagram illustrating a generation process of a mapping table used for an improvement of a network address translation method; and

FIG. 5 is a flowchart illustrating an IP address translation process in a home gateway.

### DETAILED DESCRIPTION OF THE EXEMPLARY EMBODIMENTS

Hereinafter, the preferred embodiments of the present invention will be described in detail by referring to the accompanying figures.

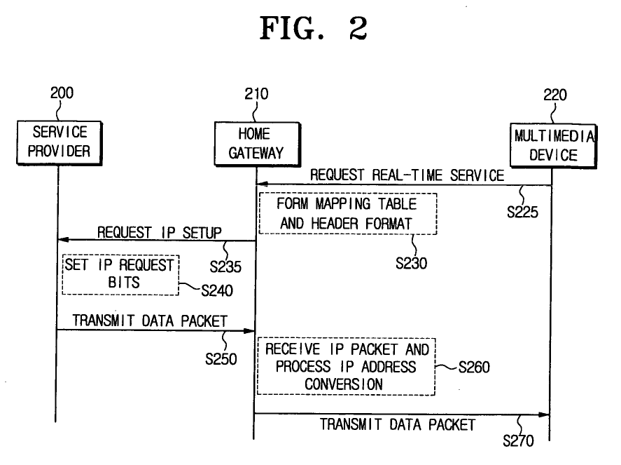

FIG. 2 is an overall flowchart illustrating a data transmission method in a home gateway according to an exemplary embodiment of the present invention. The data transmission system includes a service provider 200, a home gateway 210, and a multimedia device 220. In a narrow sense, the home gateway 210 is a functional unit or a functional device for converting protocols by connecting a plurality of networks, having incompatibility due to different protocols at each layer of an OSI reference model, to each other. The home gateway 210 transmits and receives information by converting the protocols among the plurality of different communication networks, while a bridge transmits and receives information by connecting the same communication protocols or similar communication networks to each other. Referring to FIG. 2, the multimedia device 220 requests a real-time service from the home gateway 210 (S225). The home gateway 210 forms a mapping table for converting an IP layer address and a header format according to a level of the requested service or a service of a rapid transmission speed (S230). Next, the home gateway 210 transmits an IP setup message to the service provider 200 (S235). The service provider 200 determines whether the service is possible and sets an IP address including binary codes corresponding to the media device 220 according to the IP address setup request, if possible (S240).

Next, the service provider 200 transmits a data packet including the binary codes corresponding to the media device (S250). After the home gateway 210 receives the packet in which IP request bits including the binary codes are set, the home gateway 210 performs an address conversion process using the mapping table instead of a typical NAT process if identifying the setting of the binary code bits (IP address conversion bits) in an IP packet analysis process (S260). Next, the home gateway 210 transmits the data packet to the corresponding multimedia device (S270). Hereinafter, the binary code bits (IP request bits) and the mapping table will be described in detail.

It is essential that errors do not occur at a router of the service provider 200 or another gateway and that unused bits or sender option bits are used during a transmission period of the binary code bits (IP request bits). Hereinafter, a method of utilizing the unused bits in the IP header will be described in detail.

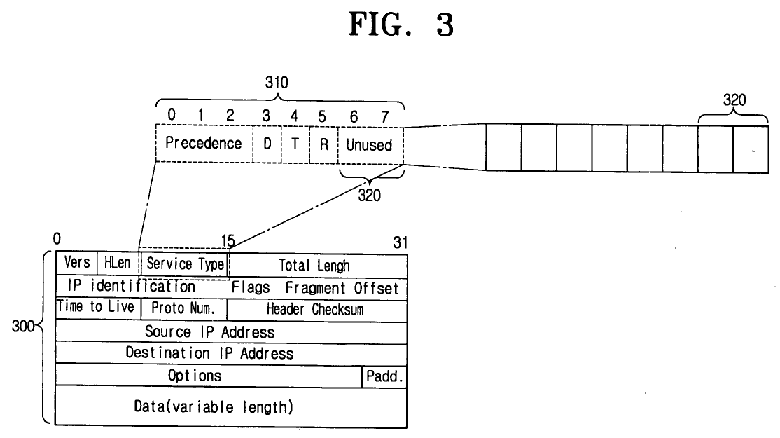

FIG. 3 is a diagram illustrating an IP service type field in an IP header used for an exemplary embodiment of the present invention. Generally, data are transmitted in IP units through an IP network, and an IP header 300 having information about the data is formed in an IP head region. The IP header 300, as shown in FIG. 3, includes fields related to the IP version, service type as information about data priority, total length of data, ID of IP, source IP address, and destination IP address. A service type field 310 is a part for displaying codes indicating presence of priority according to QoS as an Internet priority policy, and is formed with 8 bits. The service type field 310 includes a precedence part for displaying the presence of the priority of the corresponding data, a D part for displaying possibility of delay of the data to display the detailed information about the priority, a T part, and an R part for displaying reliability related to the transmission of the packet. Also, the service type field 310 included in the IP header 300 according to an exemplary embodiment of the present invention further includes a frame part 320 for distinguishing individual multimedia devices in a home network. The frame part 320 is formed with two bits and assigns binary code to the multimedia device 220 for requesting a real-time service according to a request order. For example, the frame part 320 assigns ‘01’ to the multimedia device for requesting a first real-time service and assigns ‘10’ to the multimedia device for requesting a second real-time service. In addition, the frame part 320 assigns ‘11’ to the multimedia device for requesting a third real-time service. When the multimedia device 220 requests the real-time service from the home gateway 210 after the frame part 320 assigns ‘01’, ‘10’, ‘11’ to the multimedia devices, the home gateway 210 can reject the request of the multimedia device 220. Meanwhile, when the multimedia device 220 requests the real-time service from the home gateway 210 after the frame part 320 assigns ‘01’, ‘10’, ‘11’ to the multimedia devices, the home gateway 210 can assign the first assigned binary code to the service type field of the mapping table related to the multimedia device 220 after deleting the mapping table related to the multimedia device corresponding to the first assigned binary code.

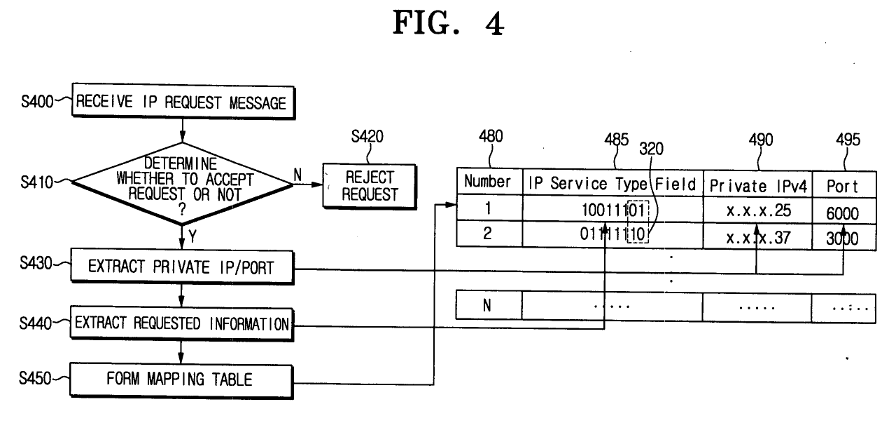

Hereinafter, a generation process of the mapping table will be described in detail. FIG. 4 is a diagram illustrating a generation process of a mapping table used for an improvement of a network address translation method. Referring to FIG. 4, the home gateway 210 receives an IP request message from the multimedia device 220 (S400) and determines whether to accept the request of the IP request message (S410). At this time, if the binary code bit is previously assigned to other multimedia device, the home gateway 210 can reject the request of the multimedia device (S420). On the other hand, if the binary code bit is not previously assigned to other multimedia device, the home gateway 210 extracts an IP address 490 and a port number 495 from the multimedia device (S430). Next, the home gateway 210 extracts an IP service type field 485 set according to service levels of the request message (S440). As described above, the IP service type field 485 includes the frame part 320 for distinguishing individual multimedia devices within the home network. Accordingly, the home gateway 210 forms a mapping table 480 for converting the addresses by assigning the IP address 490, the port number 495, and the service type field 485 (S450).

Hereinafter, a data packet reception process of the home gateway 210 from the service provider 200 and a data packet transmission process of the home gateway 210 to the corresponding multimedia device 220 will be described.

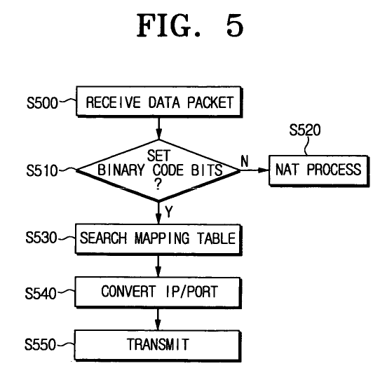

FIG. 5 is a flowchart illustrating an IP address translation process in a home gateway. Referring to FIG. 5, the home gateway 210 receives the data packet from the service provider (S500). Next, the home gateway 210 identifies the setting of the binary code bit within the service type field from an IP packet adhered to the data packet (S510). The home gateway 210 performs the conventional NAT process when the binary code bit is not set within the service type field (S520). However, the home gateway 210 searches the mapping table 480 for converting the addresses when the binary code bit is set within the service type field (S530). Next, the home gateway 210 performs an IP address and port conversion process by using the mapping table 480 (S540), and transmits the data packet to the corresponding multimedia device (S550).

As described above, the present invention improves the transmission speed, of the real-time data packet or the multimedia data packet, by being applied to selective IP packets. In addition, the present invention improves service quality and reduces a process time. Further, the present invention supports the conventional NAT processing method and has an effect of supporting the functions of only the necessary packets.

While this invention has been described in connection with what is presently considered to be the most practical and exemplary embodiments, it is to be understood that the invention is not limited to the disclosed embodiment, but, on the contrary, it is intended to cover various modifications and equivalent arrangements included within the spirit and scope of the appended claims.

What is claimed is:

1. A data transmission method comprising:
requesting, by a multimedia device, a real-time service from a home gateway within a home network;
inputting a binary code corresponding to the multimedia device to a service type field indicating priority information of data, when the home gateway forms a mapping table used for conversion of addresses;
requesting, by the home gateway; setting of an Internet Protocol (IP) address of the multimedia device from a service provider;
setting the IP address including the binary code corresponding to the multimedia device according to the request of setting the IP address; and
transmitting, from the service provider, a data packet including the binary code corresponding to the multimedia device.

2. The method according to claim 1, further comprising:
converting, at the home gateway, the IP address of the multimedia device by using the binary code; and
transmitting the data packet to the multimedia device.

3. The method according to claim 1, wherein the binary code is a two-bit code.

4. The method according to claim 1, wherein inputting the binary code, corresponding to the multimedia device to the service type field, comprises inputting 01, 10, and 11 sequentially according to a request order of the multimedia device from the home gateway.

5. The method according to claim 4, wherein when the multimedia device requests the real-time service from the home gateway after 01, 10, and 11 are input, the home gateway rejects the request of the multimedia device.

6. The method according to claim 4, wherein when the multimedia device requests the real-time service from the home gateway after 01, 10, and 11 are input, the home gateway deletes the mapping table related to the multimedia device corresponding to the first assigned binary code and assigns the first assigned binary code to the service type field of the mapping table related to the multimedia device.

7. The method according to claim 1, wherein, in forming the mapping table used for the conversion of the address, a private IP address and a port number are extracted from the multimedia device and the extracted private IP address and the extracted port number are assigned into the mapping table.

8. The method according to claim 2, wherein, in converting the IP address of the multimedia device by using the binary code, the mapping table is searched and the IP address of the multimedia device is converted.

9. The method according to claim 1, wherein, in inputting the binary code, corresponding to the multimedia device to the service type field, comprises inputting the binary code into unused bits of the service type field.

10. A data transmission system comprising:
a home gateway which converts protocols by connecting a plurality of communication networks to each other;
a multimedia device on the home network; and
a service provider which transmits data to the home gateway,
wherein the multimedia device requests a real-time service from the home gateway and receives a data packet for the real-time service,
when forming a mapping table used for conversion of an address, the home gateway inputs a binary code corresponding to the multimedia device to a service type field indicating priority information of the data, and requests the service provider to set of the Internet Protocol (IP) address of the multimedia device, and
the service provider sets the IP address including the binary code corresponding to the multimedia device according to the request to set the IP address, and transmits the data packet including the binary code corresponding to the multimedia device.

11. The system according to claim 10, wherein the home gateway converts the IP address of the multimedia device by using the binary code.

12. The system according to claim 10, wherein the home gateway transmits the data packet to the multimedia device.

13. The system according to claim 10, wherein the binary code is two bits.

14. The system according to claim 10, wherein the home gateway inputs sequentially 01, 10, and 11 according to a request order of the multimedia device from the home gateway.

15. The system according to claim 14, wherein when the multimedia device requests the real-time service from the home gateway after inputting 01, 10, and 11, the home gateway rejects the request of the multimedia device.

16. The system according to claim 14, wherein, when the multimedia device requests the real-time service from the home gate way after inputting 01, 10, and 11, the home gateway deletes the mapping table related to the multimedia device corresponding to the first assigned binary code and inputs the first assigned binary code to the service type field of the mapping table related to the multimedia device.

17. The system according to claim 10, wherein when the home gateway forms the mapping table used for the conversion of the address, the home gateway extracts a private IP address and a port number from the multimedia device and inputs the extracted private IP address and the extracted port number into the mapping table.

18. The system according to claim 11, wherein the home gateway searches the mapping table and converts the IP address of the multimedia device.

19. The system according to claim 10, wherein the home gateway inputs the binary code corresponding to the multimedia device to the unused bits of the service type field, when assigning the binary code corresponding to the multimedia device to the service type field.
